(19) United States
(12) Patent Application Publication
(10) Pub. No.: US 2006/0041609 A1
(43) Pub. Date: Feb. 23, 2006

(54) System and method for multi-dimensional lookup table interpolation

(76) Inventor: Ronald J. Pellar, Orange, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/923,382

(22) Filed: Aug. 20, 2004

(51) Int. Cl. G06F 7/38

(52) U.S. Cl. 708/290

(57) ABSTRACT

A technique for using a one or two dimensional table lookup to provide the appropriate index and fraction for a second lookup table. The second lookup table can be a multi-dimensional lookup table. The one or two dimensional lookup table allows nonlinear conversion between input values and output values obtained from the second lookup table using standard linear interpolation techniques. The one or two dimensional lookup table can nonlinearly map input values to nodes in the second lookup table, nonlinearly map fractional values, or both.

### BACKGROUND OF THE INVENTION

The present invention relates generally to interpolation techniques, and for color transformation using a lookup table.

The conversion from a n-component coordinate space to a m-component coordinate space utilizing a n-dimensional sparse lookup table along with some form of interpolation is common in a color reproduction pipeline, particularly for 3 to 3, 3 to 4, 4 to 3, and 4 to 4 dimensional input/output conversions. The mapping of the input values to the output values are generally nonlinear. The use of a sparse lookup table and linear interpolation can result in large errors in the conversion process.

Many solutions have been proposed using nonlinear node spacing in the multi-dimensional lookup table and/or nonlinear interpolation techniques. However, in many color conversion pipelines, the multi-dimensional lookup tables are restricted to linear node spacing, e.g., for Adobe PostScript™, the “Table” definition of CIEBasedDEF and CIEBasedDEFG color space arrays and the “Render Table” definition in the color rendering dictionary are required to have linear node spacing. The use of a nonlinear interpolation technique is very restrictive from a performance standpoint when compared to linear interpolation. The utilization of linear node spacing and linear interpolation can have negative consequences for color fidelity or color accuracy.

The implementation of a multi-dimensional lookup table with linear node spacing and linear interpolation is a process of converting the incoming color value, into a set of indices for table lookup of all of the values surrounding the required output value and a set of residues, or fractions, for performing interpolation between the output values. The indices and fractions required for the lookup and interpolation process can be obtained from calculations, bit masking, etc.

Referring to FIG. 1, there is illustrated a graphical comparison 100 of linear and nonlinear interpolation. The Output is plotted along the Y axis and the Input is plotted along the X axis. The region bounded by X_{I} and X_{I+1} is interpolated. The values for the linear interpolation from Y₁ to Y_{I+1} is given by
y_{I}=fₓ(Y_{I+1}−Y_{I})+Y_{I}
where Y_{I+1} and Y_{I} are the values stored at the nodes X_{I+1} and X_{I} respectively within the sparse lookup table (LUT), and fₓ is the fractional interpolation value. The fractional value fₓ can be computed by the formula

$${f}_{x} = \frac{{x}_{I} - {X}_{I}}{{X}_{I + !} - {X}_{I}}$$

that results in a linearly interpolated value y₁.

The linear interpolation of the data in results in an error of Yₙ−Y₁. The correct value yₙ can be obtained by linear interpolation by compensating for the nonlinearity of fx by shifting the value of x₁ to xₙ. Alternatively, nonlinear interpolation can reduce this error to zero (for one dimensional interpolation). With multi-dimensional lookup tables, the same fractional value or residue is used multiple times and the appropriate fraction may not be exactly correct for all interpolations. However, the fractional values used for interpolation can be set to reduce the overall error considerably when compared to linear interpolation. However, using nonlinear functions to calculate the fractional value during real time results in a severe performance penalty.

### BRIEF SUMMARY OF THE INVENTION

In accordance with an aspect of the present invention, there is disclosed herein a technique for using a one dimensional table lookup to provide the appropriate index and fraction for a multi-dimensional lookup table. Nonlinear node distribution is accomplished by nonlinear distribution of indices within the table, a nonlinear interpolation by nonlinear distribution of the fractions within the table, or both. An index table can have the indices distributed within the table to obtain the same results as a multi-dimensional lookup table having nonlinear node spacing. A fraction table can be pre-computed to yield the same results as a nonlinear interpolation technique. Both the indices table and the fraction table can be loaded with nonlinear values which together can provide a very complicated nonlinear functionality to a multi-dimensional table having linear node spacing. An alternative approach would be to use one one-dimensional lookup table of floating point numbers where the index is the whole number portion of the floating point number entry and the fraction is fractional part of the floating point number entry, i.e., I+f=>I.f.

In accordance with an aspect of the present invention, there is disclosed herein a system comprising a sparse lookup table and an interpolation lookup table. The sparse lookup table contains a plurality of nodes, wherein the plurality of nodes represent corresponding output values. The interpolation lookup table maps input values to corresponding nodes in the sparse lookup table. Thus, an input value received by the interpolation lookup table is converted to an output value based on the mapping of the interpolation lookup table to the sparse lookup table.

In accordance with an aspect of the present invention, there is disclosed herein a system comprising means adapted for determining an output value by looking up a node in a linearly spaced sparse multi-dimensional lookup table having nodes that are linearly spaced. The system further comprises means adapted for receiving an input value, being responsive to the input value to convert the input value to an index corresponding to a node in the linearly spaced multi-dimensional lookup table. The means adapted for receiving an input value nonlinearly converts the input value to the index using an interpolation lookup table.

In accordance with an aspect of the present invention, there is disclosed herein a computer readable medium of instructions, comprising means adapted for obtaining an output value from a multi-dimensional lookup table based on an index value, and means adapted for receiving an input value and converting the input value to a corresponding index value. The relationship between the input value and the corresponding index value is nonlinear.

In accordance with an aspect of the present invention, there is disclosed herein a method of performing nonlinear interpolation using a linear spaced multi-dimensional lookup table. The method includes receiving an input value to convert to an output value. The method also includes nonlinearly converting the input value to an index value corresponding to a node in a multi-dimensional lookup table. The method further including retrieving an output value from the multi-dimensional lookup table based on the index value.

Still other objects of the present invention will become readily apparent to those skilled in this art from the following description wherein there is shown and described a preferred embodiment of this invention, simply by way of illustration of as one of the best modes best suited for to carry out the invention. As it will be realized, the invention is capable of other different embodiments and its several details are capable of modifications in various obvious aspects all without from the invention. Accordingly, the drawing and descriptions will be regarded as illustrative in nature and not as restrictive.

### BRIEF DESCRIPTION OF THE SEVERAL VIEWS OF THE DRAWING

The accompanying drawings incorporated in and forming a part of the specification, illustrates several aspects of the present invention, and together with the description serve to explain the principles of the invention.

FIG. 1 is a graphical comparison of linear and nonlinear interpolation.

FIG. 2 is a block diagram of a system in accordance with an aspect of the present invention.

FIG. 3 is a block diagram of an example nonlinear distribution of an input to linearly distributed nodes.

FIG. 4 is a block diagram of an example of nonlinear distribution of fractional values to linearly distributed nodes.

FIG. 5 is a block diagram of an example of nonlinear distribution of indices and fractional values to linearly distributed nodes.

FIG. 6 is a block diagram of a for performing nonlinear interpolation using a linear spaced multi-dimensional lookup table in accordance with an aspect of the present invention.

### DETAILED DESCRIPTION OF INVENTION

Throughout this description, the preferred embodiment and examples shown should be considered as exemplars, rather than limitations, of the present invention. An aspect of the present invention uses a combination of a one or two-dimensional lookup table or a one-dimensional floating point table (interpolation table) with a linearly spaced sparse lookup table to allow nonlinear conversion between input values and output values obtained from the linearly spaced sparse lookup table using standard linear interpolation techniques to compute the output values. The present invention can map input values to index values within the lookup table nonlinearly, nonlinearly interpolate fractional values, or both. The number of input values into the table would correspond to the desired bit length, e.g., the number of color samples for a color transformation system, such as 8 bits for 256 colors, 12 bits for 4096 colors, etc. The two tables can be reduced to one table using various “packing” techniques, e.g., a two dimension table, bit shifting and addition, dual-part number representation, etc. The contents of the index and fraction tables can be pre-calculated to provide the desired behavior or accuracy. The index table can have indices distributed within the table such that they produce the same results as a multi-dimensional lookup table having nonlinear node spacing. The fraction table can be pre-computed to yield the same results as a nonlinear interpolation technique. Both the indices table and the fraction table can be loaded with nonlinear values which together can provide a very complicated nonlinear functionality to a multi-dimensional table having linear node spacing.

Referring now to FIG. 2, there is illustrated a block diagram of a system 200 in accordance with an aspect of the present invention. The system 200 uses a multi-dimensional lookup table 210, for converting input values to output values. System 200 can be implemented by computer software executing on a processor with associated memory, computer hardware, or a combination of computer hardware and software. The table 210 has nodes corresponding to the output the values. In accordance with an aspect of the present invention, the nodes are linearly spaced, such as often used in color conversion lookup tables in the Postscript™ environment. Input values 202 are provided for lookup table 210 to convert into output values 214. Input values 202 are input into one or two dimensional lookup table 204. Lookup table 204 (the interpolation table) provides indices into table 210 along path 206 and fractions along path 206 to a linear interpolator 212. One or two dimensional table 204 can provide nonlinear mapping into lookup table 210, nonlinear mapping of the fractional values used by linear interpolator 212, or both to allow nonlinear conversion between input values 202 and output values 214. For example, as will be further illustrated herein infra, for n-input values, table 204 has n entries. Table 208 has m nodes, each node corresponding to an output value. For the case where n is larger than m, in fact n can be much larger than m, then for linear mapping m/x input values are mapped to a corresponding node in table 210, where x does not vary (for example m/n). However, for nonlinear spacing, the value of x varies for the number of input values 202 mapped to nodes in table 210. For example, the first 4 input values 202 can be mapped to node 0, next 3 values to node 2, etc. Because there is not a 1 to 1 correspondence between input values 202 and nodes in table 210, there is also a fractional component. The fractional component is independent of the n to m mapping. It is determined by the relationship between input value and m. The value n is a number for the convenience of building the LUT.

In accordance with an aspect of the present invention, table 204 can either linearly or nonlinearly distribute the fractional values to linear interpolator 212 as will described in more detail herein infra. Thus, table 204 can be used to linearly distribute indices into nodes of table 210 and fractions into linear interpolator 212, nonlinearly distribute indices into nodes of table 210 and linearly distribute fractions into linear interpolator 212, linearly distribute indices into nodes of table 210 and nonlinearly distribute fractions into linear interpolator 212, or non linearly distribute indices into nodes of table 210 and fractions into linear interpolator 212.

Linear interpolator 212 combines the interpolated fractional value with the output value obtained from lookup table 210. For example, linear interpolator 212 sums the interpolated fractional value with the output value obtained from lookup table 210. As an example, if there are four input values 202 mapped to a node of table 210, each node linearly spaced by 1 from the adjacent node, then for linear interpolation of the fractional component, each input value 202 would fractionally differ by the spacing divided by the number of input values mapped to the node or ¼(0.25). Thus the first input value corresponds to the output value plus 0, the second input value to the output value plus 0.25, the third input value to the output value plus 0.5 and the fourth input value to the output value plus 0.75. For nonlinear fractional distribution, the fractional components are not evenly spaced. Thus, as an example, for four input values mapped to the same output value, the first input value corresponds to the input value plus 0, but the second input value corresponds to the input value plus 0.2, (a difference of 0.2 from the preceding input value) the third input value to the output value plus 0.5 (a difference of 0.3 from the preceding input value) and the fourth input value to the output value plus 0.9 (a difference of 0.4 from the preceding input value).

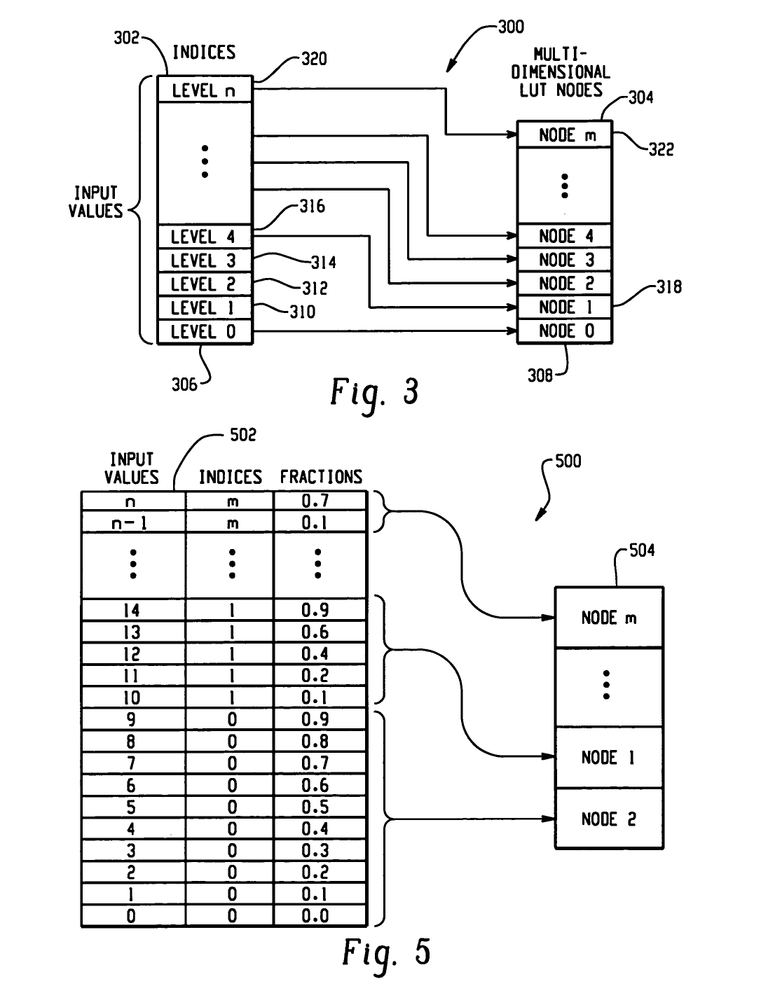

FIG. 3 is a block diagram of an example 300 nonlinear distribution of input values to linearly distributed nodes in accordance with an aspect of the present invention. This example does not include fractional values. One dimensional lookup table 302 (the interpolation table) contains levels 306, 310, 312, 314, 316, 320 corresponding to Indices which are linked to nodes of multi-dimensional lookup table 304. One dimensional lookup table 302 is has n values, starting at Level 0 306, through Level n 320. Multi-dimensional lookup table 304 has m nodes. As shown in this example, n is greater than m. The n Indicies of table 302 are mapped to m Nodes of lookup table 304. As shown in the example in FIG. 3, Level 0 306, Level 1 310 Level 2 312 and Level 3 314 are mapped to Node 0 308. For a linear system, every four Levels would be mapped to a corresponding node. However, as shown in FIG. 3, Level n 320 is the only Indices linked to Node m 322 of lookup table 304. Thus, even if lookup table 304 is a linearly distributed table, because at the lower levels of input values, four Input values are mapped to one node of lookup table 304 via lookup table 302 whereas at the higher input values, only one input value is linked to one node of lookup table 304 via lookup 302, lookup table 302 transforms the distribution of input values into lookup table 304 to a nonlinear distribution. An aspect of the present invention is that by using this technique, the overall mapping of nodes in a nonlinear manner can provide a better distribution of errors throughout the multi-dimensional lookup table 304. Since the node mapping can be arbitrary, any effect can be implemented in the one dimensional index lookup table 302 to provide a very flexible conversion process.

In accordance with an aspect of the present invention, table 204 of FIG. 2 can be a two dimensional table configured similar to table 302 mapped to a multi-dimensional lookup table 210, where multi-dimensional table 210 is configured similar to multi-dimensional lookup table 304. Such an application is particularly useful in color transformation applications where colors from one device are converted to be output on another device.

As an example to demonstrate how nonlinear output can be obtained, for n=16, for an input value of 0.3, in a linear system this would map to 0.3×16 or 4.8, the fourth node of multi-dimensional lookup table with a fractional portion of ⅘, which would be converted and added to the output of multi-dimensional lookup table 210 by linear interpolator 212. Linear interpolator 212 uses the output value of the selected node and the output value of the next node to determine the interpolated value. If node 4 has an output value of 8, and node 5 has an output value of 10 (e.g., the output value of each node is equal to 2× the node value), then linear interpolator 212 would add (10−8)*(⅘)=1.6 to the output value of node 4 (8), yielding an output of 9.6. However, by using one dimensional lookup table 204 configured similar to one dimensional lookup table 302, the output value would be the output of node 1 (in this example 2). The output of linear interpolator 212 would be the same (4−2)*(⅘)=1.6 so the final output value would be 3.6. as opposed to 9.6 that was obtained by using multi-dimensional lookup table 210 without one dimensional lookup table 204 because a different node of multi-dimensional lookup table 210 is being used.

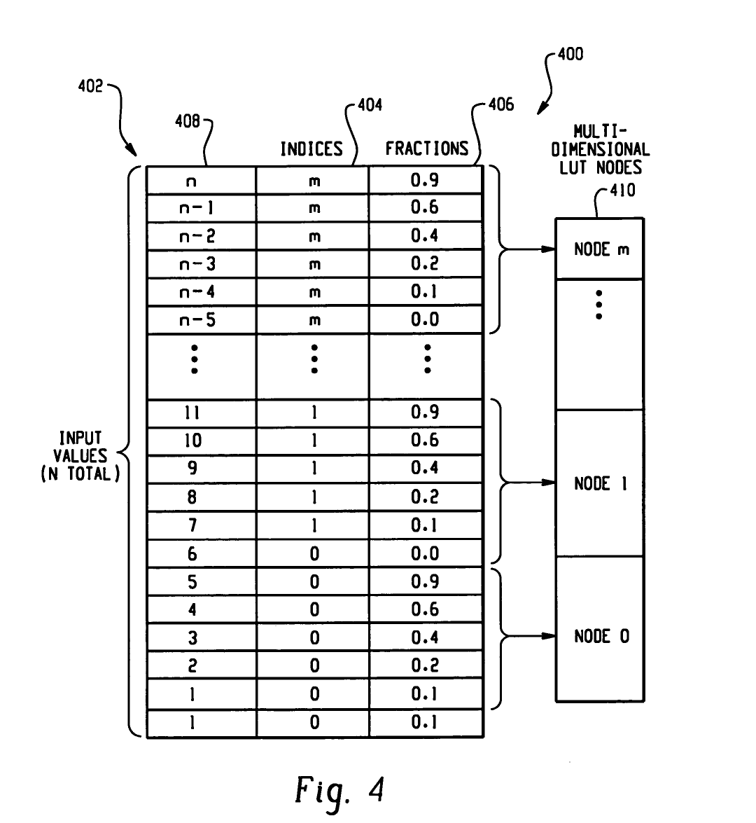

FIG. 4 is a block diagram 400 of an example of nonlinear mapping of fractional values. In this example, the Indices of table 402 (the interpolation table) are linearly distributed, while the fractions 406 are nonlinearly distributed. Input values 408 from 0 to n are mapped with a one to one correspondence to Indices 404 and Fractions in lookup table 402. As shown, there are six input values 408 mapped to the same Indices 404. Each of the indices 404 corresponds to a Node in Multi-dimensional lookup table 410. Because the same amount of indices 404 are mapped to each node in multi-dimensional lookup table 410, the indices 404 are linearly mapped. However, the Fractions 406 are not linearly distributed. Although each node in multi-dimensional lookup table 410 have the same six fractions mapped, 0.0, 0.1, 0.2, 0.4, 0.6 and 0.9, the fractions are not linearly distributed for each node. That is because the spacing between the fractions for each input value is not linear, e.g., the spacing between the first two input values is 0.1 while for the last two input values its 0.3.

In accordance with an aspect of the present invention, table 204 can nonlinearly distribute the fractional values to linear interpolator 212 by using a table configured similar to table 402. By using a table configured like table 402, table 204 can linearly distribute indices into nodes of table 210 and nonlinearly distribute fractions into linear interpolator 212.

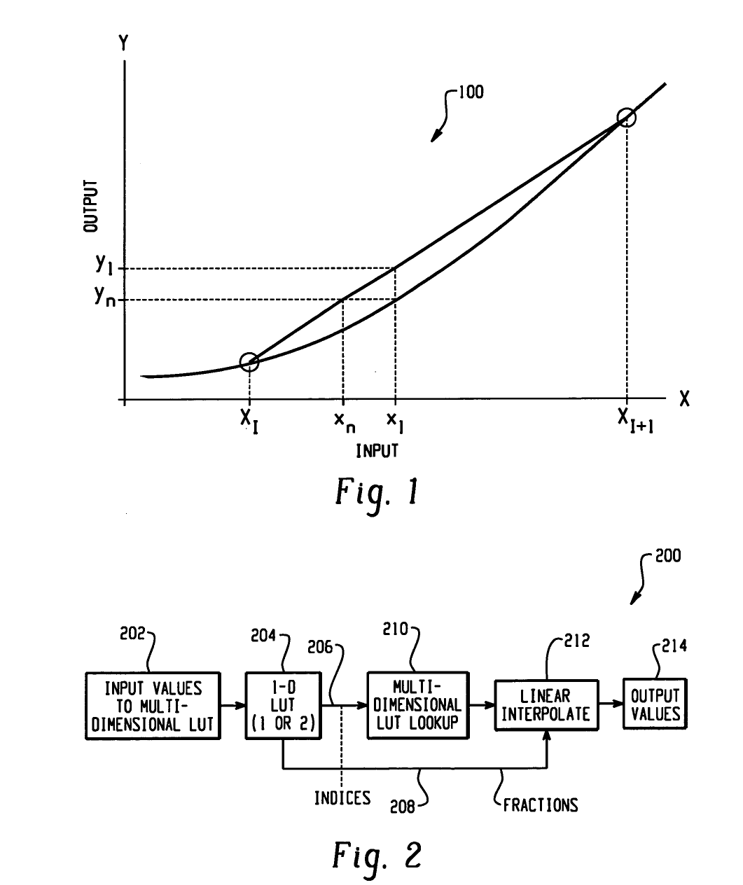

FIG. 5 is a block diagram 500 of an example of nonlinear mapping of indices (Indices) and fractional values (Fractions). A lookup table 502 (the interpolation table) is shown with the corresponding input values along with the mapping to multi-dimensional lookup table 504. For the first ten input values (0 . . . 9), the Indices is mapped to Node 0 of multi-dimensional lookup table 504, and the Fractions change linearly, from 0.0 to 0.9 by 0.1 for each input value for input values 0-9. Input values 10-14 map to Node 1, while the Fractions begin to vary nonlinearly by stepping by 0.1 between input values 10-11 and stepping by 0.3 between input values 13-14 and eventually stepping by 0.6 for input values n-1 to n. Thus, as can be seen by examining lookup table 502, the Indices are nonlinear because 10 input values mapped to Node 0, then 5 input values to Node 2, and eventually 2 input values, n-1 and n, map to Node m. Similarly, the Fractions are also nonlinearly mapped. For input values 0-9 the fractional values vary linearly from 0.0 to 0.9, each input value being a 0.1 step. However, for input values 10-14, the Fractions step by 0.1, 0.2, 0.2 and 0.3, and for input values n-1 and n the Fractions step by 0.6. Therefore, by configuring lookup table 204 (FIG. 2) similar to lookup table 502, the Indices and Fractions obtained by using a linearly spaced multi-dimensional table 210 can compensate for nonlinear characteristics. Using the example of FIG. 1, where linear interpolation for x₁ would yield y₁ instead of the correct value of yₙ, the present invention enables the correct value yₙ to be obtained using linear interpolation by shifting x from x₁ to xₙ.

In accordance with an aspect of the present invention, table 204 (FIG. 2) can nonlinearly distribute indices into table 210 and fractional values to linear interpolator 212 by configuring table 204 similar to table 502. This allows for very flexible, nonlinear mapping of input values 202 to output values 214.

Although the preceding descriptions illustrated tables in one dimension, the present invention can be suitably adapted for any number of dimensions. In the case of a one dimensional system, the linear interpolator interpolates using two indexes. For a multidimensional system, the linear interpolator uses two indexes for each dimension (e.g., for a three dimensional system, six indexes).

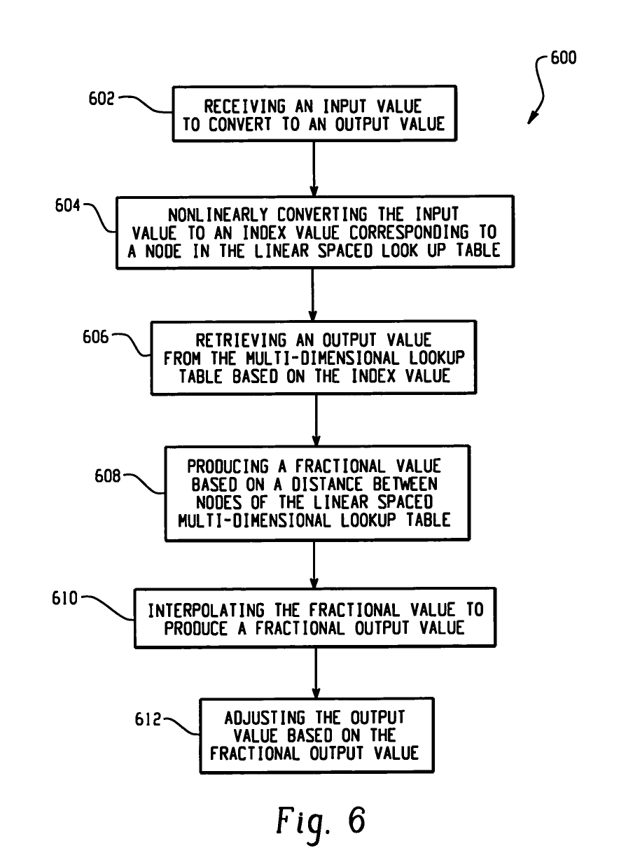

In view of the foregoing structural and functional features described above, a methodology in accordance with various aspects of the present invention will be better appreciated with reference to FIG. 6. While, for purposes of simplicity of explanation, the methodology of FIG. 6 is shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect the present invention. The methodology can be implemented by computer software executing on a processor with associated memory, computer hardware, or a combination of computer hardware and software.

Referring now to FIG. 6, there is illustrated a method 600 for performing nonlinear interpolation using a linear spaced multi-dimensional lookup table. At 602, an input value is received that is to be converted to an output value. The input value can be received as an index and fraction, or If necessary the input value is converted to an index and fraction depending on the number of bits (e.g., a value of 0.62 is converted to an 8 bit value by multiplying 0.62 by 128, yielding an index of 79 and a fraction value of 0.36).

At 604, the input value is nonlinearly converted to an index value corresponding to a node in the linear spaced multi-dimensional lookup table. The input value is nonlinearly converted to an index value by using a one or two dimensional lookup table that maps input values to index values in the linear spaced multi-dimensional lookup table. The one or two dimensional lookup table nonlinearly converts input values by varying the number of input values assigned to nodes in the multi-dimensional lookup table. For a linear conversion, the same number of input values is mapped to each node in the multi-dimensional lookup table. As an example, for 16 input values, and a linear spaced multi-dimensional lookup table with 8 nodes, each node is mapped two consecutive input values, e.g., input values 0,1 to node 1 (index value 1), input values 2,3 to node 2 (index value 2), . . . input values 15, 16 to node 8 (index value 8) whereas for nonlinear spacing the number of input values per node varies, e.g., four input values (0,1,2,3) can be mapped to node 1 (index value 1), three input values (4,5,6) to node 2 (index value 2), until all of the input values are mapped to a node. The output value is then retrieved from the multi-dimensional lookup table based on the index value at 606.

At 608, a fractional value based on a distance between nodes of the linear spaced multi-dimensional lookup table is produced. The fractional value can be linearly interpolated or nonlinearly interpolated. For example, a one dimensional lookup table configures similar to table 302 in FIG. 3 can be used for linearly interpolating the fractional value, whereas a lookup table configured similar to as table 402 (FIG. 4) or 502 (FIG. 5) can be used for nonlinear interpolation. At 610, the fractional value is interpolated to produce a fractional output value. The fractional output value is based on the actual difference between the output values for the corresponding index values. For example, if index value 1 corresponds to an output value of 10 and index value 2 corresponds to an output value of 15, then the fractional value will be between 0 and 5 (15−10). For example if the fractional value is 0.8, then the fractional output value is 5*0.8=4.

At 612, the output value is adjusted based on the fractional output value. This is done by combining the output value with the fractional output value. Using the example of the last paragraph, for an input value of 1.8, the output value for an index of 1 is 10, the fractional output value is 4, the adjusted output value is obtained by summing the output value with the fractional output value, or 10+4=14.

In accordance with an aspect of the present invention, the one or two dimensional lookup table used to map input values to the multi-dimensional lookup table can adjusted to produce a desired linear or nonlinear output. Another aspect of the present invention is that the present invention enables a multi-dimensional lookup table to be prepared for a device, such as a color rendering device, and if any adjustments are needed, the adjustments can be provided by the one or two dimensional lookup table used to map input values to the multi-dimensional lookup table.

What has been described above includes exemplary implementations of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims interpreted in accordance with the breadth to which they are fairly, legally and equitably entitled.

1. A system, comprising
a sparse multi-dimensional lookup table containing a plurality of nodes, the plurality of nodes having corresponding output values; and
an interpolation lookup table for mapping input values to corresponding nodes in the sparse multi-dimensional lookup table;
wherein an input value received by the interpolation lookup table is converted to an output value based on the mapping of the interpolation lookup table to the sparse multi-dimensional lookup table.

2. The system of claim 1, wherein the sparse multi-dimensional lookup table is linearly spaced.

3. The system of claim 2, wherein the mapping of the interpolation lookup table to the sparse multi-dimensional lookup table is nonlinear.

4. The system of claim 1, wherein the interpolation lookup table is configured to receive n input values, the sparse multi-dimensional lookup table having m nodes, where n and m are integers greater than zero, and n is greater than m.

5. The system of claim 1, wherein the interpolation lookup table is configured to produce a fractional value corresponding to a space between the corresponding node for the input value and a next node.

6. The system of claim 5, further comprising a linear interpolator, the linear interpolator configured to receive the fractional value from the interpolation lookup table, and the output value corresponding to the input value from the sparse multi-dimensional lookup table and producing an adjusted output value based on a linear interpolation of the fractional value combined with the output value.

7. The system of claim 6, wherein the fractional values are nonlinearly spaced in the interpolation lookup table.

8. The system of claim 7, wherein the mapping of input values from the interpolation to the output values in the sparse multi-dimensional lookup table is non-linear.

9. The system of claim 8, wherein the interpolation lookup table is configured to receive n input values, the second lookup table having m nodes, where n and m are integers greater than zero, and n is greater than m.

10. The system of claim 1, wherein the interpolation lookup table is a one-dimensional floating point lookup table, and wherein floating point values are produced by summing the indices and fractions.

11. The system of claim 1, wherein the interpolation lookup table is a two-dimensional lookup table, wherein one dimension provides the indices into the sparse multi-dimensional lookup table and a second dimension provides a fractional value.

12. A system, comprising
means adapted for determining an output value by looking up a node in a linearly spaced sparse multi-dimensional lookup table, the node corresponding to a corresponding output value; and
means adapted for receiving an input value and responsive the input value to employ an interpolation lookup table to convert the input value to an index corresponding to the node in the linearly spaced sparse multi-dimensional lookup table
wherein the means adapted for determining an output value is responsive to the means adapted for receiving an input value.

13. The system of claim 12, wherein the interpolation lookup table nonlinearly converts the input value to the index.

14. The system of claim 12, wherein the means adapted for receiving an input value is configured to receive n input values, the means adapted for determining an output value table having m nodes, where n and m are integers greater than zero, and n is greater than m, the interpolation lookup table maps the n input values to the m nodes.

15. The system of claim 12, further comprising
means adapted for interpolating;
wherein the means adapted for receiving an input value is configured to produce a fractional value corresponding to a distance between consecutive output values in the linearly spaced sparse multi-dimensional lookup table; and
wherein the means adapted for interpolating calculates an interpolated fractional value corresponding to the fractional value of the distance between output values and adds the interpolated fractional value to the output value.

16. The system of claim 15, wherein the fractional value produced by the means adapted for receiving is non-linear.

17. The system of claim 15, wherein the interpolation lookup table is a one-dimensional floating point table.

18. A computer readable medium of instructions, comprising:
means adapted for obtaining an output value from a sparse multi-dimensional lookup table based on an index value; and
means adapted for receiving an input value and converting the input value to a corresponding index value using an interpolation table.

19. The computer readable medium of instructions of claim 18, wherein the relationship between the input value and the corresponding index value is nonlinear.

20. The computer readable medium of instructions of claim 19, further comprising
means adapted for interpolating;
wherein the means adapted for receiving is configured to produce a fractional value corresponding to a distance between output values stored in the multi-dimensional lookup table; and
wherein the means adapted for interpolating calculates an interpolated fractional value corresponding to the fractional value of the space between output values and adds the interpolated fractional value to the output value.

21. The computer readable medium of instructions of claim 20, wherein the means adapted for receiving is configured to produce fractional values nonlinearly.

22. A method for performing nonlinear interpolation using a linear spaced sparse lookup table, comprising:
receiving an input value to convert to an output value;
converting the input value to an index value using an interpolation lookup table; and
retrieving an output value from the multi-dimensional lookup table based on the index value.

23. The method of claim 22, wherein the interpolation lookup table provides a non-linear relationship between the input value and the index value.

24. The method of claim 22, further comprising:
the converting the input value further comprising producing a fractional value based on a distance between nodes of the linear spaced multi-dimensional lookup table;
interpolating the fractional value to produce a fractional output value; and
adjusting the output value based on the fractional output value.

25. The method of claim 24, wherein the fractional value is non-linear.

26. The method of claim 24 wherein the converting the input value uses an interpolation lookup table that has floating point values, corresponding to the index and fractional value.
